(19) United States
(12) Patent Application Publication
(10) Pub. No.: US 2017/0004396 A1
(43) Pub. Date: Jan. 5, 2017

(54) USER-SPECIFIC TASK REMINDER ENGINE

(71) Applicant: MICROSOFT TECHNOLOGY LICENSING, LLC, REDMOND, WA (US)

(72) Inventors: NIKROUZ GHOTBI, REDMOND, WA (US); JASON CREIGHTON, BELLEVUE, WA (US); AJOY NANDI, REDMOND, WA (US); RYEN WILLIAM WHITE, WOODINVILLE, WA (US); CALEB BRAZIER, SEATTLE, WA (US)

(21) Appl. No.: 14/755,885

(22) Filed: Jun. 30, 2015

(51) Int. Cl. G06N 3/00; G06F 3/0484

(52) U.S. Cl. CPC G06N 3/006; G06F 3/04842

(57) ABSTRACT

Aspects of the technology described herein provide a more efficient user interface by providing suggestions that are tailored to a specific user's interests. The suggestions may be provided by a personal assistant or some other application running on a user's computing device. A goal of the technology described herein is to provide relevant suggestions when the user can and actually wants to use them. The suggestions are designed to provide information or services the user wants to use.

### BACKGROUND

A personal assistant program provides services traditionally provided by a human assistant. For example, a personal assistant can update a calendar, provide reminders, track activities, and perform other functions. Some personal assistant programs can respond to voice commands and audibly communicate with users. Personal assistants can suggest restaurants, music, tasks, movies, and other items to a user when the user might have an interest in one of these items.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Aspects of the technology described herein provide a more efficient user interface by providing contextual task reminders (hereafter “task reminder” or “reminder”) derived from unstructured communications. The communications can include locations, people, or entitles that are analyzed to identify a task. A goal of the technology is to provide only the task reminders the user wants and at a point in time when the user wants the reminder. There's a distinction between the point in time that the user wants the reminder and the point in time that the task is due. Reminder time can be some n hours before a task deadline. As explained, the reminder time may be inferable from the nature of the task. The tasks described in the task reminders can take the form of commitments made by the user and requests made to the user. The reminders may be provided by a personal assistant or some other application running on a user's computing device.

The tasks can be identified using a computer learning model, such as a neural network or deep neural network. The model can be tailored to a specific user by retraining a generic model with feedback received from a user. The feedback may be implicit or explicit. In one aspect, an interface to solicit feedback is surfaced when a user dismisses the reminder. The specific feedback can specify whether the task was correctly identified and whether the task was surfaced in the correct context. The specific feedback can also help identify the types of tasks the user actually wants help tracking.

Once generated, the current context of a user can be monitored to trigger a suggestion associated with the association rule when the context part of the association rule matches the current context.

### BRIEF DESCRIPTION OF THE DRAWINGS

Aspects of the technology described in the present application are described in detail below with reference to the attached drawing figures, wherein:

FIG. 1 is a block diagram of an exemplary computing environment suitable for implementing aspects of the technology described herein;

FIG. 2 is a diagram depicting an exemplary computing environment that can utilize user feedback to generate a customized task identification model, in accordance with an aspect of the technology described herein;

FIG. 3 is a diagram depicting an exemplary task reminder interface, in accordance with an aspect of the technology described herein;

FIG. 4 is a diagram depicting an exemplary task feedback interface, in accordance with an aspect of the technology described herein;

FIG. 5 is a diagram depicting a method of generating a user-specific task model, in accordance with an aspect of the technology described herein; and

FIG. 6 is a diagram depicting a method of generating a user-specific task model, in accordance with an aspect of the technology described herein.

### DETAILED DESCRIPTION

The technology of the present application is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein provide a user-specific task identification model. The user-specific model is tailored to a particular user by incorporating feedback from the user when training and/or retraining a model. The user feedback can be explicit or implicit. Implicit feedback includes a user ignoring a task reminder or using a task reminder. Ignoring a task reminder can be implicit negative feedback suggesting something is wrong with the task reminder, but the exact problem with the task reminder can be difficult to discern. Utilization of a task reminder is implicit positive feedback suggesting the task was accurately identified and surfaced at a convenient time. There may be other forms of implicit feedback, such as how long the user dwelled on the reminder. The user hovering over the reminder and reading it for a few moments can mean something different from the user just glancing at the reminder. Implicit feedback can also be inferred from the completion of a task after the user viewed the reminder. For example, if Sarah sends Tom an email which says, “Call me later tonight” a request reminder may be presented to Tom. If Tom then calls Sarah, then the technology identifies that Tom both saw the request reminder and then proceeded to make a call to Sarah. This can be positive feedback indication that the reminder helped the user to accomplish said task.

The task identification model used with aspects of the technology described herein can be a machine learning model, such as a deep neural network. The model can be initially trained using training data that is not user specific. The training data may include unstructured communications that are labeled by one or more users to identify pertinent task aspects. Once trained, the model can be fed user communications and identify tasks within the communications. The identified tasks can include commitments made by the user and requests that other people made. For example, the user could commit to pick up his daughter from soccer practice on the way home from work in a text message sent by the user. Similarly, the user can receive a request to pick up his daughter on the way home from work in an email or text. The task identification model could receive these communications and generate a task reminder for the user to pick up his daughter on the way home from work.

The task reminder may also include a contextual trigger generated by the task application model. Contextual triggers specify criteria that define an optimal time to present a task reminder to the user. For example, the contextual trigger may specify a time of day when the user typically leaves work and use this time to trigger a reminder to pick up his daughter from soccer. In another example, a contextual trigger could cause the task reminder to be presented to the user when the user's location data indicates he is driving home from work. For example, GPS data could indicate movement at a speed and route consistent with the user driving. The task reminder could also be based on properties of the task (quick reply vs. detailed reply) and properties of the user's current situation (e.g., 10 minutes until next meeting).

Task reminders may be presented by a personal digital assistant operating on one or more of the user's client devices. Exemplary client devices include smartphones, tablets, augmented reality headsets, computers, navigation systems, and other devices. The task reminder may be a visual indication on a user's client device or may be audibly transmitted to the user.

The task reminder can explain the identified task to the user and suggest one or more actions. For example, the task reminder could offer to provide traffic data for a route to a soccer complex associated with the user's daughter. The task reminder can also include a dismiss function. The exact description used on the dismiss function can vary but the purpose is to permanently dismiss the reminder, in contrast to a “remind me later” or other response. Upon receiving a dismiss instruction from the user, aspects of the technology described herein may present an additional feedback interface to the user to inquire why the task reminder was dismissed. The feedback interface may provide one of several specific reasons for the user to select. Exemplary reasons include the task has already been completed, the task is not important, the task is invalid (e.g., is not a commitment or request), and the personal assistant does not need to provide assistance for this type of task.

Feedback may be collected and provided to a model trainer that uses the feedback as input to retrain the model and generate a user-specific task application model. In one aspect, the model generation occurs in a data center. The user-specific model can then analyze additional communications received from the user to generate user-specific task reminders. These task reminders can be communicated to the user as described above, and the user can be provided additional opportunities to provide feedback. In addition to the explicit feedback, implicit feedback can be provided to the model generator to use as input and generate a user-specific task application model.

As used herein, “unstructured communications” are communications without a schema for communicating task information. For example, many airlines use a schema to communicate ticket or reservation information. The schema may be explicitly provided by the author of the email (e.g., in the case of schema.org) or be clearly identifiable from the email (e.g., using HTML tags and layout information). The airline communications are structured. Unstructured communications can be written in natural language form and can be processed using natural language processing techniques.

Tasks can take the form of requests and commitments. The requests may be made by the user or of the user. For example, a user may request that a friend pick him up for work or the friend may request that the user pick him up for work. Similarly, the commitments may be made by the user or to the user by another person. For example, a user may commitment to complete a project or the user may receive a commitment from another person to complete a project. Many of the examples used herein describe the user making a commitment or receiving a request, but the technology can apply equally to the user making a request or receiving a commitment.

The identification of tasks and presentation of reminders can facilitate multiple complex scenarios. The feedback can help determine which scenarios are of interest to the user and improve the performance of useful scenarios. As an example, a utility (e.g., water company, power company, phone company, telecommunications company, cable company) or financial institution (e.g., bank or credit card company) may send an email or text reminding a user to pay a bill. The technology described herein can extract a “bill pay” task from the email. The “bill pay” task may include information such as the payee, amount, payment due date, and other information from the email such as a link to the sender's payment or bill detail webpage.

Once the task information is extracted, a reminder can be created. The reminder can include some or all of the task information. In addition, the task reminder can include information to help the user complete the task. For example, the task reminder could include a link to the user's online checking or bill payment interface. In one scenario, the payment information is automatically communicated to the checking or bill payment interface so the information does not need to be reentered by the user.

The task reminder can also include a surface time and surface channel. The surface time defines when the reminder is communicated to the user. The channel is the method through which the reminder is communicated. Exemplary channels include a displayed notification and an audible notification. The channel can also include an intrusiveness level. For example, a high level of intrusiveness includes displaying a notification over an active interface. A low level of intrusiveness includes adding the reminder to a list the user needs to proactively check to find the notification. The intrusiveness of the reminder can change overtime. For example, a bill pay reminder may initially be added to a passive list. As the payment date approaches, an intrusive reminder may be provided if the bill has not been paid.

The technology described herein allows the user to provide feedback that is used to determine whether the task was correctly identified and the task information correctly extracted. The feedback can also be used to determine whether the best reminder channel was used. In the scenario described above, the user may be able to provide feedback that the “bill pay” task was correctly identified, but that the intrusiveness of the reminder was too great. Alternatively, the feedback could indicate the bill pay task was correctly identified, but the payment was already made, thus the reminder was not helpful. Once the feedback is incorporated into a personalized model, bill pay task reminders may be surfaced in the future in a manner consistent with the feedback.

The feedback interface can be scenario specific. For example, a bill pay reminder could be dismissed and then a feedback interface with bill pay specific feedback options provided. Exemplary bill pay feedback options include, “automatic payments set up for this payee,” “payment already made,” “payment amount is wrong,” “payment due date is wrong,” “not a valid payee,” “not interested in “bill pay” reminders,” and “not interested in “bill pay” reminders for this payee.” Bill pay is just one example, and the technology described herein can enable the optimization of multiple scenarios.

Having briefly described an overview of aspects of the technology described herein, an exemplary operating environment suitable for use in implementing the technology is described below.

### Exemplary Operating Environment

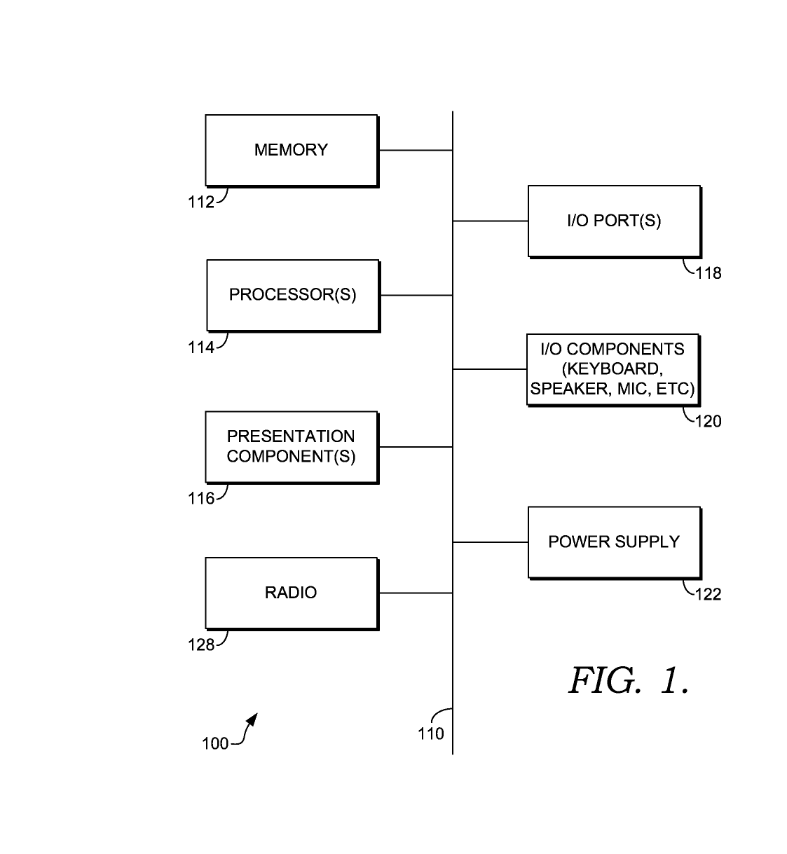

Referring to the drawings in general, and initially to FIG. 1 in particular, an exemplary operating environment for implementing aspects of the technology described herein is shown and designated generally as computing device 100. Computing device 100 is but one example of a suitable computing environment and is not intended to suggest any limitation as to the scope of use of the technology described herein. Neither should the computing device 100 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or a combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 112 includes computer storage media in the form of volatile and/or nonvolatile memory. The memory 112 may be removable, non-removable, or a combination thereof. Exemplary memory includes solid-state memory, hard drives, optical-disc drives, etc. Computing device 100 includes one or more processors 114 that read data from various entities such as bus 110, memory 112, or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices, including I/O components 120, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In embodiments, a pen digitizer (not shown) and accompanying input instrument (also not shown but which may include, by way of example only, a pen or a stylus) are provided in order to digitally capture freehand user input. The connection between the pen digitizer and processor(s) 114 may be direct or via a coupling utilizing a serial port, parallel port, and/or other interface and/or system bus known in the art. Furthermore, the digitizer input component may be a component separate from an output component such as a display device, or in some embodiments, the usable input area of a digitizer may coexist with the display area of a display device, be integrated with the display device, or may exist as a separate device overlaying or otherwise appended to a display device. Any and all such variations, and any combination thereof, are contemplated to be within the scope of embodiments of the technology described herein.

An NUI processes air gestures, voice, or other physiological inputs generated by a user. Appropriate NUI inputs may be interpreted as ink strokes for presentation in association with the computing device 100. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as stereoscopic camera systems, infrared camera systems, RGB camera systems, and combinations of these, for gesture detection and recognition. Additionally, the computing device 100 may be equipped with accelerometers or gyroscopes that enable detection of motion. The output of the accelerometers or gyroscopes may be provided to the display of the computing device 100 to render immersive augmented reality or virtual reality.

A computing device may include a radio 128. The radio transmits and receives radio communications. The computing device may be a wireless terminal adapted to receive communications and media over various wireless networks. Computing device 100 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

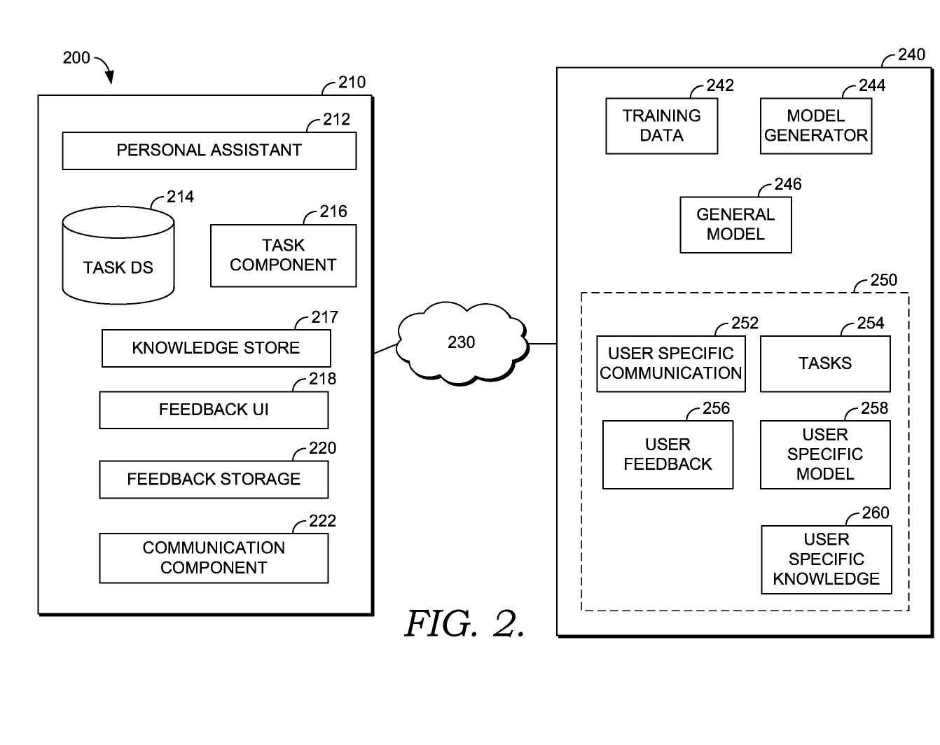

Turning now to FIG. 2, an exemplary wide area computing environment 200 is shown, in accordance with an aspect of the technology described herein. The computing environment 200 includes a mobile device 210 connected through wide area network 230 with personal assistant server 240. According to aspects of the technology described herein, the user-specific task identification model may be generated in a data center with task reminders provided to the client device. In another aspect, the technology described herein is deployed entirely in a data center or client device. FIG. 2 shows a mixed environment where the model is generated on the data center and the task reminders are communicated through a client device that also receives feedback, but aspects are not limited to this example.

The client device 210 could be a computing device similar to the one described in FIG. 1. Exemplary client devices include a smartphone, car navigation system, tablet, personal computer, virtual reality glasses, augmented reality glasses, and such. The client device 210 includes a personal assistant application 212, a task data store 214, a task reminder component 216, a feedback component 218, a feedback storage component 220, and a communication collection component 222.

The personal digital assistant application 212 helps the user perform tasks through the one or more computing devices, such as client device 210 and other devices associated with the user. It should be noted that implementations of the technology described herein are not limited to use with a personal assistant application. The technology could be deployed with text applications, email applications, calendar applications, social media applications, and such. A user is associated with the computing device when she uses the computing device on a regular basis. The user does not need to own the computing device, for example, a user's work computer could be owned by the employer but, nevertheless, be considered “associated with the user.” Similarly, a user could share a family computer with multiple people, and the family computer can be considered “associated with the user.” In one aspect, a user is able to designate the devices that he or she is associated with. In one aspect, a user is associated with each device on which an instance of the personal assistant application is installed and on which the user has registered his or her account information or user identification with the personal digital assistant application.

The personal digital assistant application 212 can help the user complete both computing tasks, such as sending an email or submitting a search query, and real world tasks, such as scheduling a pickup time for a user's dry cleaning on the way home from work. Real world tasks, as used herein, occur, in part, outside of computers. For example, the exchange of physical good or services is an example of a real world task. Electronic tasks occur exclusively between computing devices and users of those computing devices. Displaying through a computer display or printing the result of a computerized communication have a real world element but are, nevertheless, considered electronic tasks for this application.

The personal digital assistant application 212 can monitor other applications and operating system functions. For example, the personal digital assistant application 212 may be able to monitor or have access to sensor data from one or more sensors on the client device 210. For example, the personal digital assistant application 212 may have access to accelerometer data, gyro data, GPS location data, Wi-Fi location data, image data from a camera, sound data generated by a microphone, touch data from a touchscreen, and other information. Sensor data from these sensors could be used to determine whether a contextual trigger associated with a task reminder has been satisfied.

The personal digital assistant application 212 can monitor user activities within one or more other applications and store a record of this activity forming a personal data record. The knowledge store 217 stores details of events performed through the smartphone or other devices running an instance of the personal digital assistant application. For example, the user could read an email on their mobile device 210 causing a record of an “email read” event to be created. The “email read” record can describe a time and date when the email was read along with details describing the email, such as the recipients, subject line, description of attachments, etc. Similar information could be used to describe a text event. A call event could record the time and date of a call, call duration, and contact information (e.g., name, phone number) for the other person on the call. The contact information could be determined from caller ID information or taken from a local contact data store when the phone number matches an existing contact's phone number. This information could be communicated to user-specific knowledge store 260 and synchronized with knowledge stores on other user devices (not shown).

In another example, the personal digital assistant application 212 could generate a walking event that is stored in the knowledge store 217. The absence of light from a camera could indicate that the phone is in the user's pocket and accelerometer data could indicate that the user is walking with the phone. The start time and stop time could be recorded to describe the walk event along with geographic location and/or route. The geographic information could be gathered from a GPS or other location technology within the smartphone.

A drive event could describe an instance of the user traveling in a car. As with the walking event, the start and stop time of the drive event could be recorded along with geographic information such as a route. Additional information could include businesses visited before, after, or during the drive event. Geographic location information could be used to identify a business. Additionally, financial information could be gathered to confirm that a purchase was made during the drive event. A particular car may be identified by analyzing available Bluetooth connections, including when the smartphone connects to the car through a wireless or wired connection.

A specific type of drive event may include a public transportation event. The user's use of public transportation may be identifiable upon the user accessing a Wi-Fi connection provided by the transportation company. Further, route information could be analyzed to determine that the user is on public transportation. For example, the route information including stops could be analyzed to determine that the route follows a bus route and the stops coincide with bus stops. Similarly, a route could be compared with a known train route to determine that public transportation is being used. Additionally, payment information may be analyzed to determine that public transportation is being used, as well as to gather additional details about the public transportation. In one instance, the payment information is provided through a near field communication system in the smartphone.

The personal digital assistant application 212 may record an entertainment event record. The location information for the smartphone may be compared with a database of known events. For example, the phone's location at a football stadium coinciding with a known ballgame event can cause an entertainment record to be created. As with other events, payment information, calendar information, email information, and other data may be combined to determine that an entertainment event record should be created and to provide details. The calendar information can include a calendar description of the event. The email information can include a discussion of the event with friends, a payment receipt, or other information related to the event.

Information recorded by the personal digital assistant application 212 may be considered user knowledge and stored in personal knowledge store 217. The user knowledge can be used to identify tasks, build task reminders, build contextual triggers and determine when the contextual triggers have been satisfied.

The task data store 214 can store task reminders received from a task identification model. The task data store can include task reminders received from the user-specific task identification model and a generic task navigation model. The personal assistant 212 or other components can access the task data store 214 to evaluate trigger criteria associated with individual task reminders and surface a task reminder when the trigger criteria is satisfied.

Each task reminder may include a description of a particular task and trigger criteria as described previously. The trigger criteria is used to determine when a task reminder should be presented to a user. The technology described herein can also use trigger criteria to specify what level of intrusiveness is appropriate to surface these reminders to the user, and use the feedback to build a personalized model for the determine an appropriate level for a reminder. For example, the technology described herein can build a personalized model that recognizes the importance of certain tasks, such as requests to call family. For important requests, the personal digital assistant can reach out proactively through ringing, vibration, and other methods. For lower priority tasks, (e.g., an email that requests “email me back by next week”) the digital assistant can surface the task on the home screen where the user must proactively go and find it.

There are many levels we can surface these tasks, Notification with sounds \vibration, a silent notification, live tile, the assistant home screen, etc

The task reminder component 216 can act as the interface with the user-specific task application model 250 or the generic task identification model 246 to receive tasks that have been stored in the task data store 214. In an alternative aspect, the task reminder component 216 can include a task identification model, either generic for user-specific, and process communication data to identify tasks and generate task reminders in a client only implementation.

Feedback component 218 solicits feedback from the user. In one aspect, the feedback component 218 can generate an interface to solicit feedback from the user upon the user dismissing a task reminder. The user feedback interface can be presented as a visual interface on a client device's display or audibly. The user may interact with a visual interface by making gestures, touching specific reasons presented on the interface, using a mouse, keyboard, voice instructions, and such. The user may respond to a feedback interface by audibly replying in natural language.

The feedback interface may provide several different specific reasons why the user dismissed a task reminder. In an aspect, the specific reasons include the task was not identified correctly. The task may not be identified correctly when the user has not made an actual commitment or received a request to which the user intends to follow through with. For example, the user communication could include a suggestion that is incorrectly identified as a request for the user to follow through with. For example, the user may receive a text message stating “steak for dinner tonight.” The task identification model may analyze this text in addition to other communications and generate a task reminder that the user is having steak for dinner tonight with the sender of the text. In reality, this could just be a suggestion from the sender of the text inquiring about the user's preference for dinner with no agreement being reached. This type of feedback could then be fed back into the user-specific model generator, such as model generator 244, to generate a user-specific model that would be less likely to identify a similar text as a request in the future. The feedback could also be provided to a general model.

In an aspect of the technology described herein, the specific rationale could be the task is already completed. This type of feedback indicates that the timing criteria used to determine when the task reminder is communicated to the user is incorrect. This feedback could then be presented to a model generator, such as model generator 244, to generate an updated user-specific model 258, which is more likely to associate a similar task request with more accurate contextual triggers.

Another aspect is that the extracted task is not valid (e.g., not a commitment or request). This is to be expected given the subjective nature of the task, the imperfect classification models for extracting tasks, and subtleties and nuances in human language/semantics that make it difficult to be correct all of the time. Providing feedback on errors associated with task extraction can help improve the performance of the task extractors.

In an aspect, the specific reason can be the task is not important. This indicates that the task was correctly identified, but that the user does not deem it important enough for task reminders to be generated. In other words, completion of the task may be optional in the user's mind or something the user gets to eventually, but a reminder is not wanted.

In another aspect, the specific reason is the user does not need the personal assistance's help with the task. For example, the personal assistant may provide a task reminder about a task the user completes habitually, such as getting a haircut every other Friday afternoon. In this situation, the task is correctly identified, but the task reminder is unwelcome. The unwanted feedback suggests the task was correctly identified, but that the presentation of a task reminder is not deemed helpful by the user.

In one aspect, the specific reasons fall into distinct categories that can be consumed by the model generator to tune the model to the user's specific interests. In other words, the feedback interface follows a schema that can be incorporated into the model for training purposes. In one aspect, the feedback is used to label communications that were originally analyzed to generate the task reminder. Processing the task reminder with the additional annotated data can help train the model to take the desired action in the future. The desired actions can include extracting a valid task more often and presenting reminder at the correct time with the correct level of intrusiveness.

The feedback storage component 220 can store user feedback until a time when it is convenient to communicate the user feedback through network 230 to user feedback component 256 in the data store. A convenient time can include when the user is connected to a Wi-Fi network rather than a telecommunications network to aid excess data usage. Other environmental factors such as present battery life and bandwidth usage may be evaluated to communicate the feedback at a time when sufficient battery life is available and the communication will not do not disrupt an ongoing communication session, such as streaming music or video.

Communication collection component 222 can collect user communications sent and received from the client device for future analysis. The communication collection component 222 can communicate communications over network 230 to the user-specific communication component 252. The communication collection component 222 can include factors that identify communications received by the client device the right to on the personal assistant server 240. For example, web-based email can be communicated directly to the user-specific communication component 252 instead of by the client device. On the other hand, text messages received by the client device may be forwarded to the user-specific communication component 252.

In one aspect, the communication collection component 222 provides a privacy interface for the user to specify what types of communications may or may not be communicated to the user-specific communication component 252 or otherwise choose to identify tasks. The privacy interface can allow the user to opt in or opt out of the program entirely. The privacy interface may also allow the user to specify the associated communications that may be analyzed or not to generate tasks. For example, the user may authorize the task identification technology to use emails or texts received from or sent to people in the user's contact database or social network.

The personal assistant server 240 is a remote service that includes generic and user-specific task identification functionality. The personal assistant server can also perform other functions to help enable various personal assistant scenarios. The generic components provide task notification models that may be applicable to multiple users. For example, the generic training data 242, the model generator 244, and the generic task identification model 246 can be applied to different users. The generic models may take into account specific user characteristics. For example, a first generic model may be generated for men within a certain age bracket and a second generic model may be generated for men in a second age bracket. Similarly, general categories of user interests may be used to generate different generic models. Nevertheless, this type of model tailored to a specific demographic category of users is not considered user-specific for the purpose of this disclosure.

The personal assistant server 240 includes the user-specific task application model 250. The user-specific task application model 250 can include user-specific communications component 252, tasks component 254, user feedback component 256, and user-specific model component 258.

The user-specific communication component 252 can collect communications from one or more sources for a specific user. The user-specific communications may be received from one or more client devices. The user-specific communications may also be received from one or more online services, such as the user's social network, web-based email, text messages (SMS), instant messages, and other services. The user-specific communications may be fed into the general model component 246 or the user-specific model component 258 to identify tasks that are stored in the tasks component 254.

The tasks component 254 can store tasks in the form of task reminders that include a description of the task and contextual criteria for triggering a presentation of the specific task to the user. The tasks component 254 can communicate tasks to one or more of the user's client devices, such as client device 210.

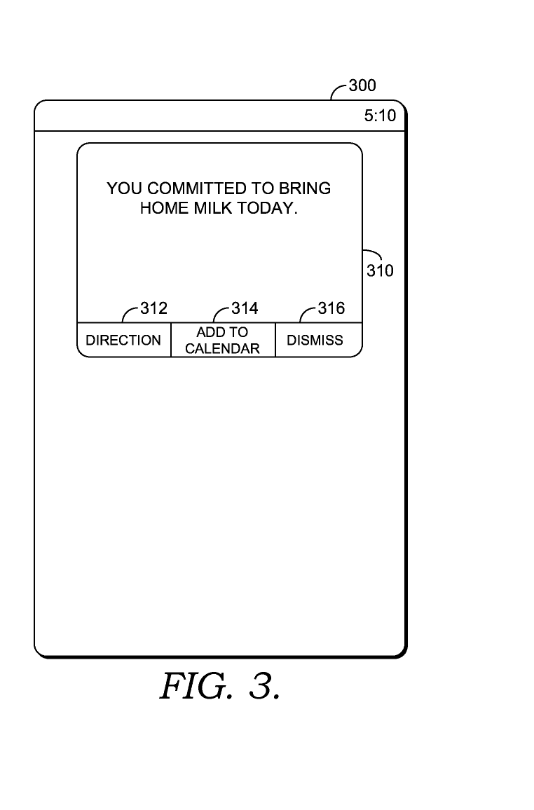

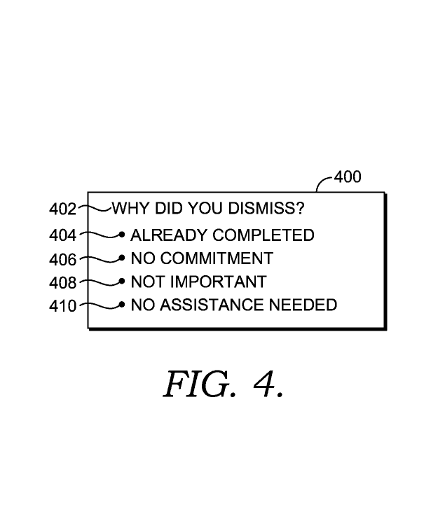

The user feedback component 256 can store user feedback received from one or more client devices and/or received directly from an interface generated by the user feedback component 256. The user interface generated by the user feedback component 256 can be similar to the user interface described previously with reference to the feedback component 218 and illustrated subsequently with reference to FIGS. 3 and 4.

The user-specific model 258 can be generated by the model generator 244 including the use of generic training data 242 and the user-specific feedback. Once generated by the model generator 244, the user-specific model 258 may be used subsequently instead of one or more generic models 246. The user-specific 258 can be updated over time as additional feedback is received. In contrast, the generic model 246 can be static across multiple users. In other words, the user user-specific model 258 can replace the generic model 246. Training the user-specific model 258 and the generic model 246 can occur when the client device 210 is offline.

The training data component 242 can store training data for use by the model generator 244. The training data may include annotated communications and other task outcome data that can help the model generator build a model that can receive unknown communications and generate similar task outcomes. The general model 246 includes one or more generic models generated by the model generator without user-specific feedback.

The model generator 244 generates models that can take user actions, such as communications as input, and identify or extract tasks and task related information, such as ideal reminder times and formats. In one aspect, the model generator can generate a task extraction model that identifies tasks and a separate model that identifies reminder times and methods.

The model generator 244 can perform several tasks including extraction of tasks from electronic communications, such as messages between or among one or more users (e.g., a single user may send a message to oneself or to one or more other users). For example, an email exchange between two people may include text from a first person sending a request to a second person to perform a task, and the second person making a commitment (e.g., agreeing) to perform the task. The email exchange may convey enough information for the system to automatically determine the presence of the request to perform the task and/or the commitment to perform the task. In some implementations, the email exchange does not convey enough information to determine the presence of the request and/or the commitment. Whether or not this is the case, the system may query other sources of information that may be related to one or more portions of the email exchange. For example, the system may examine other messages exchanged by one or both of the authors of the email exchange or by other people. The system may also examine larger corpora of email and other messages. Beyond other messages, the system may query a calendar or database of one or both of the authors of the email exchange for additional information. In some implementations, the system may query traffic or weather conditions at respective locations of one or both of the authors.

Herein, “extract” is used to describe determining or identifying a request or commitment in a communication. For example, a system may extract a request or commitment from a series of text messages. Here, the system is determining or identifying a request or commitment from the series of text messages, but is not necessarily removing the request or the commitment from the series of text messages. In other words, “extract” in the context used herein, unless otherwise described for particular examples, does not mean to “remove”.

Herein, a process of extracting a request and/or commitment from a communication may be described as a process of extracting “task content”. In other words, “task content” as described herein refers to one or more requests, one or more commitments, and/or projects comprising combinations of requests and commitments that are conveyed in the meaning of the communication. In various implementations, interplay between commitments and requests may be identified and extracted. Such interplay, for example, may be where a commitment to a requester generates one or more requests directed to the requester and/or third parties (e.g., individuals, groups, processing components, and so on. For example, a commitment to a request from an engineering manager to complete a production yield analysis may generate secondary requests directed to a manufacturing team for production data.

In various implementations, a process may extract a fragment of text containing a commitment or request. For example, a paragraph may include a commitment or request in the second sentence of the paragraph. Additionally, the process may extract the text fragment, sentence, or paragraph that contains the commitment or request, such as the third sentence or various word phrases in the paragraph.

In various implementations, a process may augment extracted task content (e.g., requests or commitments) with identification of people and one or more locations associated with the extracted task content. For example, an extracted request may be stored or processed with additional information, such as identification of the requester and/or “requestee(s)”, pertinent location(s), times/dates, and so on.

Once identified and extracted by a computing system, task content (e.g., the proposal or affirmation of a commitment or request) of a communication may be further processed or analyzed to identify or infer semantics of the commitment or request including: identifying the primary owners of the request or commitment (e.g., if not the parties in the communication); the nature of the task content and its properties (e.g., its description or summarization); specified or inferred pertinent dates (e.g., deadlines for completing the commitment or request); relevant responses such as initial replies or follow-up messages and their expected timing (e.g., per expectations of courtesy or around efficient communications for task completion among people or per an organization); and information resources to be used to satisfy the request. Such information resources, for example, may provide information about time, people, locations, and so on. The identified task content and inferences about the task content may be used to drive automatic (e.g., computer generated) services such as reminders, revisions (e.g., and displays) of to-do lists, appointments, meeting requests, and other time management activities. In some examples, such automatic services may be applied during the composition of a message (e.g., typing an email or text), reading the message, or at other times, such as during offline processing of email on a server or client device. The initial extraction and inferences about a request or commitment may also invoke automated services that work with one or more participants to confirm or refine current understandings or inferences about the request or commitment and the status of the request or commitment based, at least in part, on the identification of missing information or of uncertainties about one or more properties detected or inferred from the communication.

In some examples, task content may be extracted from multiple forms of communications, including digital content capturing interpersonal communications (e.g., email, SMS text, instant messaging, phone calls, posts in social media, and so on) and composed content (e.g., email, note-taking and organizational tools such as OneNote® by Microsoft Corporation of Redmond, Wash., word-processing documents, and so on).

As described below, some example techniques for identifying and extracting task content from various forms of electronic communications may involve language analysis of content of the electronic communications, which human annotators may annotate as containing commitments or requests. Human annotations may be used in a process of generating a corpus of training data that is used to build and to test automated extraction of commitments or requests and various properties about the commitments or requests. Techniques may also involve proxies for human-generated labels (e.g., based on email engagement data or relatively sophisticated extraction methods). For developing methods used in extraction systems or for real-time usage of methods for identifying and/or inferring tasks or commitments and their properties, analyses may include natural language processing (NLP) analyses at different points along a spectrum of sophistication. For example, an analysis having a relatively low-level of sophistication may involve identifying key words based on simple word breaking and stemming. An analysis having a relatively mid-level of sophistication may involve consideration of larger analyses of sets of words (“bag of words”). An analysis having a relatively high-level of sophistication may involve sophisticated parsing of sentences in communications into parse trees and logical forms. Techniques for identifying and extracting task content may involve identifying attributes or “features” of components of messages and sentences of the messages. Such techniques may employ such features in a training and testing paradigm to build a statistical model to classify components of the message. For example, such components may comprise sentences or the overall message as containing a request and/or commitment and also identify and/or summarize the text that best describes the request and/or commitment.

In some examples, techniques for extraction may involve a hierarchy of analysis, including using a sentence-centric approach, consideration of multiple sentences in a message, and global analyses of relatively long communication threads. In some implementations, such relatively long communication threads may include sets of messages over a period of time, and sets of threads and longer-term communications (e.g., spanning days, weeks, months, or years). Multiple sources of content associated with particular communications may be considered. Such sources may include histories and/or relationships of/among people associated with the particular communications, locations of the people during a period of time, calendar information of the people, and multiple aspects of organizations and details of organizational structure associated with the people.

In some examples, techniques may directly consider requests or commitments identified from components of content as representative of the requests or commitments, or may be further summarized. Techniques may extract other information from a sentence or larger message, including relevant dates (e.g., deadlines on which requests or commitments are due), locations, urgency, time-requirements, task subject matter (e.g., a project), and people. In some implementations, a property of extracted task content is determined by attributing commitments and/or requests to particular authors of a message. This may be particularly useful in the case of multi-party emails with multiple recipients, for example.

Beyond text of a message, techniques may consider other information for extraction and summarization, such as images and other graphical content, the structure of the message, the subject header, length of the message, position of a sentence or phrase in the message, date/time the message was sent, and information on the sender and recipients of the message, just to name a few examples. Techniques may also consider features of the message itself (e.g., the number of recipients, number of replies, overall length, and so on) and the context (e.g., day of week). In some implementations, a technique may further refine or prioritize initial analyses of candidate messages/content or resulting extractions based, at least in part, on the sender or recipient(s) and histories of communication and/or of the structure of the organization.

In some examples, techniques may include analyzing features of various communications beyond a current communication (e.g., email, text, and so on). For example, techniques may consider interactions between or among commitments and requests, such as whether an early portion of a communication thread contains a commitment or request, the number of commitments and/or requests previously made between two (or more) users of the communication thread, and so on.

In some examples, techniques may include analyzing features of various communications that include conditional task content commitments or requests. For example, a conditional commitment may be “If I see him, I'll let him know.” A conditional request may be “If the weather is clear tomorrow, please paint the house.”

In some examples, techniques may include augmenting extracted task content (e.g., commitments and/or requests) with additional information such as deadlines, identification (e.g., names, ID number, and so on) of people associated with the task content, and places that are mentioned in the task content.

In some examples, a computing system may construct predictive models for identifying and extracting requests and commitments and related information using machine learning procedures that operate on training sets of annotated corpora of sentences or messages (e.g., machine learning features). In other examples, a computing system may use relatively simple rule-based approaches to perform extractions and summarization.

In some examples, a computing system may explicitly notate task content extracted from a message in the message itself. In various implementations, a computing system may flag messages containing requests and commitments in multiple electronic services and experiences, which may include products or services such as revealed via products and services provided by Windows®, Cortana®, Outlook®, Outlook Web App® (OWA), Xbox®, Skype®, Lync® and Band®, all by Microsoft Corporation, and other such services and experiences from others. In various implementations, a computing system may extract requests and commitments from audio feeds, such as from phone calls or voicemail messages, SMS images, instant messaging streams, and verbal requests to digital personal assistants, just to name a few examples.

The user-specific task application component 250 can also include a user knowledge base 260 that is used to generate task reminders in combination with the user-specific model. The user-specific knowledge base 260 can include detailed information about the user, such as the user's relationship to other users and the names and online or electronic identification information for the related users. For example, the knowledge base may identify a user's spouse, parents, children, coworkers, neighbors, or other groups of people. The user-specific knowledge base may also include information about the user's interests, activities, and other relevant information. The user-specific data store can include a user's home location and frequent locations visited, such as shopping locations, restaurants, entertainment locations, and such. The user-specific data store can include information about the user's work location and hierarchical job information, such as the user's manager and who directly reports to the user. Hierarchical work information can help identify whether a task is important as well as its urgency. For example, an apparent request from the user's manager may be more urgent and important than a request received from a coworker.

The user knowledge base 260 can also include communication histories between people. The communication histories can quantify various communication characteristics that can help identify tasks and establish ideal reminder times. The communication characteristics can include a number of messages received from a person, number of messages sent to a person, frequency of response to a person, and average response time to a person. As example, the average response time could be used to set a time to present a reminder for a task of responding a message. The response frequency could be used to determine whether or not a request to respond to a message should be listed as a task.

Turning now to FIG. 3, an exemplary task reminder interface is shown, in accordance with an aspect of the technology described herein. Client device 300 displays a visible task reminder interface 310. The task reminder interface 310 includes a message “you committed to bring milk home today.” Alternatively, the message could be a sentence or other text unit taken directly from a message. The task reminder may include a link to the source of the task (e.g., an email or text message) or otherwise identify the source of the task. This description may be derived by a task identification model analyzing one or more communications received or sent by the user. The user interface 310 also includes three action buttons. The first action button 312 offers to provide the user directions to a nearby store where the user can purchase milk. The second action button 314 offers to create a calendar entry to remind the user to bring milk home. The third action button 316 allows the user to dismiss the task reminder. Upon dismissing the task reminder 310, a feedback interface may be generated. FIG. 3 depicts just one potential implementation and the number and specific buttons can vary based on the type of task identified, and the particular device capabilities.

Turning now to FIG. 4, an explicit feedback interface 400 is shown, in accordance with the aspect of the technology described herein. The feedback interface 400 asks the user why the task reminder was dismissed. Four selectable options are provided in FIG. 4. The first option 404 is that the task has already been completed. The second option 406 is that no commitment was made. This feedback suggests that the task was incorrectly identified. The third option 408 suggests that the task is not important to the user. The fourth option 410 states that no assistance is needed with the task. Other specific rationales are possible. Though not shown, a text entry box may be provided for the user to write freeform feedback that can be collected and reviewed to improve the system.

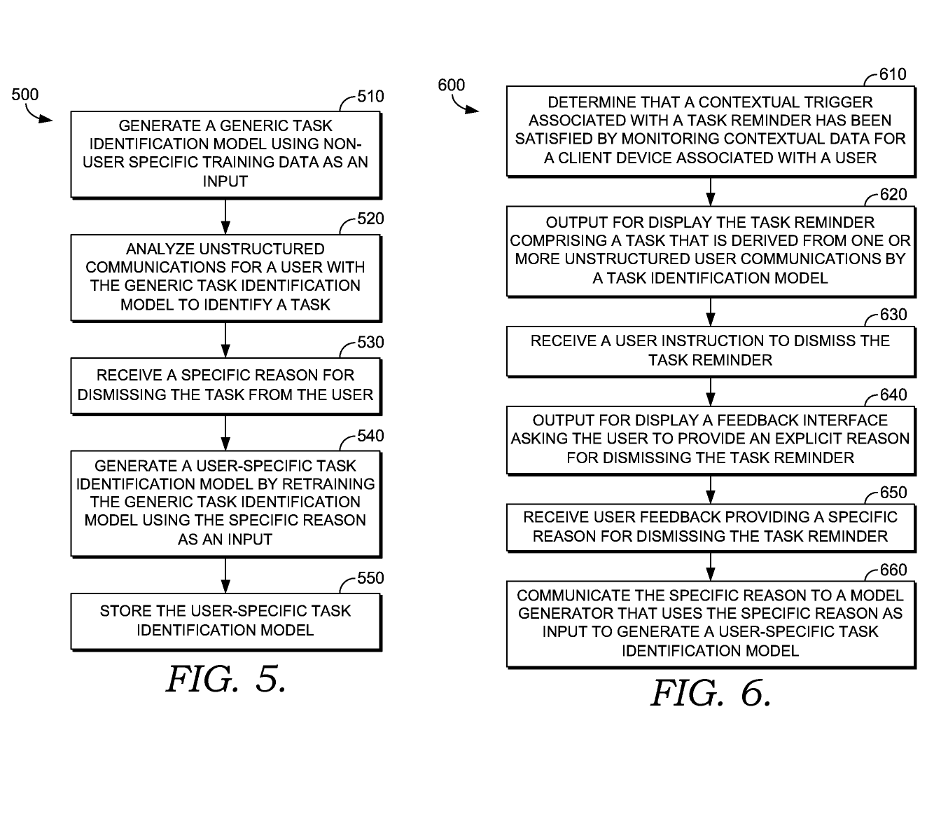

Turning now to FIG. 5, a method 500 of generating a user-specific task identification model is provided. Method 500 may be performed on a client device or in a data center.

At step 510, a generic task identification model is generated using non-user-specific training data as an input.

At step 520, unstructured communications for a user are analyzed with the generic task identification model to identify a task. The tasks may be included in a task reminder that is communicated to a user. The user may then dismiss the task reminder.

At step 530, a specific reason for dismissing the task is received from the user. The specific reason may be provided by the user selecting one of several reasons offered on a feedback interface, such as feedback interface 400. Step 530 can refer to receiving the selection from a client device at a data center that is building a task identification model.

At step 540, a user-specific task identification model is generated by retraining the generic task identification model using the specific reason as an input to the training process.

At step 550, the user-specific task identification model is stored. The model may then be used to evaluate user communications to identify tasks.

Turning now to FIG. 6, a method 600 of generating a user-specific task identification model is provided. At step 610, a contextual trigger associated with a task reminder is determined to have been satisfied by monitoring contextual data for a client device associated with a user. At step 620, the task reminder comprising a task that is derived from one or more unstructured user communications by a task identification model is output for display.

At step 630, a user instruction to dismiss the task reminder is received, for example, as illustrated with reference to FIG. 3.

At step 640, a feedback interface asking the user to provide an explicit reason for dismissing the task reminder is output for display.

At step 650, user feedback is received providing a specific reason for dismissing the task reminder.

At step 660, the specific reason is communicated to a model generator that uses the specific reason as input to generate a user-specific task identification model.

Aspects of the technology have been described to be illustrative rather than restrictive. It will be understood that certain features and subcombinations are of utility and may be employed without reference to other features and subcombinations. This is contemplated by and is within the scope of the claims.

The invention claimed is:

1. A computing system comprising:
a processor; and
computer storage memory having computer-executable instructions stored thereon which, when executed by the processor, implement a method of generating a user-specific task reminder, the method comprising:
(1) outputting for display a task reminder comprising a task that is derived from one or more unstructured communications by a task identification model;
(2) receiving an instruction to dismiss the task reminder from a user;
(3) outputting for display a feedback interface asking the user to select a reason for dismissing the task reminder;
(4) receiving an input from the user providing a specific reason for dismissing the task reminder; and
(5) communicating the specific reason to a model update component that retrains the task identification model using the specific reason as input to generate an updated task identification model.

2. The system of claim 1, wherein the task is a request made by the user in one or more of the unstructured communications.

3. The system of claim 1, wherein the one or more unstructured user communications include one or more of an email sent by the user, an email received by the user, a text sent by the user, a text received by the user, and a social post associated with the user.

4. The system of claim 1, wherein the task is a commitment made by the user in one or more of the unstructured communications.

5. The system of claim 1, wherein the task is a request made by a third party in one or more of the unstructured communications.

6. The system of claim 1, wherein the specific reason is the task is not identified correctly.

7. The system of claim 1, wherein the specific reason is that the task reminder is not necessary for the task.

8. A method of generating a user-specific task identification model, the method comprising:
generating a generic task identification model using non-user-specific training data as an input;
analyzing unstructured communications for a user with the generic task identification model to identify a task;
receiving a specific reason for dismissing the task from the user;
generating a user-specific task identification model by retraining the generic task identification model using the specific reason as an input; and
storing the user-specific task identification model.

9. The method of claim 8, wherein the method further comprises:
receiving additional unstructured user communications; and
analyzing the additional unstructured user communications with the user-specific task identification model to identify a new task.

10. The method of claim 9, wherein the task is a commitment received by the user from another person in one or more of the unstructured communications.

11. The method of claim 9, wherein the method further comprises communicating a task reminder for the new task to a client device associated with the user.

12. The method of claim 11, wherein the task reminder comprises both a description of the new task and a contextual trigger for displaying the task reminder to the user.

13. The method of claim 8, wherein the task is a request made by a third party in one or more of the unstructured communications.

14. The method of claim 8, wherein the specific reason is that the task is not identified correctly.

15. The method of claim 8, wherein the specific reason is that the task has already been completed.

16. A method of generating user-specific contextual association rules comprising:
determining that a contextual trigger associated with a task reminder has been satisfied by monitoring contextual data for a client device associated with a user;
outputting for display the task reminder comprising a task that is derived from one or more unstructured user communications by a task identification model;
receiving a user instruction to dismiss the task reminder;
outputting for display a feedback interface asking the user to provide an explicit reason for dismissing the task reminder;
receiving user feedback providing a specific reason for dismissing the task reminder; and
communicating the specific reason to a model generator that uses the specific reason as input to generate a user-specific task identification model.

17. The method of claim 16, wherein the method further comprises:
sending one or more communications to a data center based user-specific task identification model for analysis; and
receiving a new task reminder generated by the user-specific task identification model.

18. The method of claim 16, wherein the method further comprises limiting a number of times feedback can be solicited during a time period.

19. The method of claim 16, wherein the specific reason is that the task is not correctly identified.

20. The method of claim 16, wherein the task reminder is presented audibly by a personal digital assistant component.
